(19) United States
(12) Patent Application Publication
(10) Pub. No.: US 2026/0360723 A1
(43) Pub. Date: Nov. 12, 2026

(54) BATTERY CELL CATHODE WITH DIELECTRIC LITHIUM-CONDUCTIVE PARTICLE ADDITIVE

(71) Applicant: GM Global Technology Operations LLC, Detroit, MI (US)

(72) Inventors: Yong Lu, Shanghai (CN); Zhe Li, Shanghai (CN); Haijing Liu, Shanghai (CN)

(21) Appl. No.: 19/223,560

(22) Filed: May 30, 2025

(30) Foreign Application Priority Data
May 8, 2025 (CN) 202510593250.9

(51) Int. Cl. H01M 4/525; H01M 4/131; H01M 4/62; H01M 10/0525

(52) U.S. Cl. CPC H01M 4/525; H01M 4/131; H01M 4/624; H01M 4/625; H01M 10/0525; H01M 2220/20

(57) ABSTRACT

According to several aspects of the present disclosure, a cathode, and a battery for an electric vehicle are provided. The battery includes a battery cell, which further includes a cathode current collector, a cathode disposed on at least one surface of the cathode current collector, an anode disposed on an anode current collector, a separator positioned between the cathode and the anode, and an electrolyte configured for carrying ions between the cathode and the anode. The cathode includes a cathode active material, nanoparticles dispersed in the cathode active material, a conductive filler, and a binder. The nanoparticles include dielectric lithium-conductive particles, and the nanoparticles have a median particle size (D50) between 100 and 500 nanometers (nm). The anode includes at least one of graphite, silicon, a silicon carbon composite, lithium titanate (LTO), or titanium niobium oxide (TNO).

### INTRODUCTION

The present disclosure relates to a battery cell, and more particularly, to a cathode having a dielectric lithium-conductive particle additive.

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides a source of lithium ions and determines capacity and average voltage of a battery. The anode stores and releases lithium ions received from the cathode when energy is needed. The separator prevents the cathode and anode from contacting and shorting out the battery, and the electrolyte provides a medium between the cathode and anode through which the lithium ions travel.

Cathode electrodes and anode electrodes are formed by coating current collectors with active cathode material and active anode material, respectively. The coatings often include active materials, which are responsible for the electrochemical reactions that store and release energy during battery operation.

While present battery and cathode chemistries achieve their intended purpose, there is a need for new and improved cathode chemistries that offer improved structural and chemical stability, efficient electronic and ionic conductivities, and better cyclability.

### SUMMARY

According to several aspects of the present disclosure, a cathode for a battery cell is provided. The cathode includes cathode active materials, nanoparticles dispersed in the cathode active material, a conductive filler, and a binder. The nanoparticles are dielectric lithium-conductive particles and include lithium aluminum titanium phosphate (LATP), and the nanoparticles have a median particle size (D50) between 100 and 500 nanometers (nm).

In accordance with another aspect of the disclosure, the battery cell operates under a cutoff voltage higher than 4.25 V.

In accordance with another aspect of the disclosure, the cathode active material includes at least one of lithium nickel manganese cobalt oxide (NCM), nickel manganese (NM) (where the nickel is greater than 70 wt. %), lithium manganese rich (LMR), lithium nickel manganese oxide (LNMO), or lithium cobalt oxide (LCO) with a single crystal structure.

In accordance with another aspect of the disclosure, the cathode active material has a single-crystal structure.

In accordance with another aspect of the disclosure, the cathode active material has a median particle size (D50) between 2 microns (μm) and 4 microns (μm).

In accordance with another aspect of the disclosure, the conductive filler includes at least one of carbon nanotubes, graphene, or a conductive polymer.

According to several aspects of the present disclosure, a battery for an electric vehicle is provided. The battery includes a battery cell, which further includes a cathode current collector, a cathode disposed on at least one surface of the cathode current collector, an anode disposed on an anode current collector, a separator positioned between the cathode and the anode, and an electrolyte configured for carrying ions between the cathode and the anode. The cathode includes a cathode active material, nanoparticles dispersed in the cathode active material, a conductive filler, and a binder. The nanoparticles include dielectric lithium-conductive particles, and the nanoparticles have a median particle size (D50) between 100 and 500 nanometers (nm). The anode includes at least one of graphite, silicon, a silicon carbon composite, lithium titanate (LTO), or titanium niobium oxide (TNO).

In accordance with another aspect of the disclosure, the battery cell operates under a cutoff voltage higher than 4.25 V.

In accordance with another aspect of the disclosure, the cathode active material includes at least one of lithium nickel manganese cobalt oxide (NCM), nickel manganese (NM) (where the nickel is greater than 70 wt. %), lithium manganese rich (LMR), lithium nickel manganese oxide (LNMO), or lithium cobalt oxide (LCO).

In accordance with another aspect of the disclosure, the cathode active material has a single-crystal structure.

In accordance with another aspect of the disclosure, the cathode active material includes at least one of lithium manganese oxide (LMO), lithium nickel manganese aluminum oxide (NCMA), nickel cobalt aluminum oxide (NCA), lithium nickel manganese aluminum oxide (NMA), lithium iron phosphate (LFP), or lithium iron manganese phosphate (LFMP).

In accordance with another aspect of the disclosure, the cathode active material has a median particle size (D50) between 2 microns (μm) and 4 microns (μm).

In accordance with another aspect of the disclosure, the nanoparticles include lithium aluminum titanium phosphate (LATP).

In accordance with another aspect of the disclosure, the nanoparticles include at least one of lithium zirconate (LiZrO₃), lithium niobate (LiNbO₃), or lithium tantalate (LiTaO₃).

In accordance with another aspect of the disclosure, the nanoparticles are between 0.5-1.5 wt. % of the cathode.

In accordance with another aspect of the disclosure, the nanoparticles have a median particle size (D50) between 200 and 400 nanometers (nm).

In accordance with another aspect of the disclosure, the conductive fillers include at least one of carbon nanotubes, graphene, or a conductive polymer.

In accordance with another aspect of the disclosure, the binder is polyvinylidene fluoride (PVDF).

In accordance with another aspect of the disclosure, the cathode includes cathode active materials between 77-98.9 wt. %, nanoparticles between 0.1-3 wt. %, a conductive filler between 0.5-5 wt. %, and a binder between 0.5-8 wt. %.

According to several aspects of the present disclosure, a battery for an electric vehicle is provided. The battery includes a battery cell, which further includes a cathode current collector, a cathode disposed on at least one surface of the cathode current collector, an anode disposed on an anode current collector, a separator positioned between the cathode and the anode, and an electrolyte configured for carrying ions between the cathode and the anode. The nanoparticles include dielectric lithium-conductive particles, and the nanoparticles have a median particle size (D50) of about 400 nanometers (nm). The anode includes at least one of graphite, silicon, a silicon carbon composite, lithium titanate (LTO), or titanium niobium oxide (TNO).

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle having an electric motor powered by a battery pack with a cathode having nano-sized dielectric lithium-based particles, in accordance with the present disclosure.

FIG. 2 is a cross section schematic view of a battery cell in the battery pack in the vehicle shown in FIG. 1, where the battery cell includes a cathode having nano-sized dielectric lithium-based particles, in accordance with the present disclosure.

FIG. 3 illustrates a cross section schematic view of the cathode illustrated in FIG. 2, where the cathode has nano-sized dielectric lithium-based particles, in accordance with the present disclosure.

FIG. 4 is a graphical representation illustrating an improvement in discharge rate when using the cathode with nano-sized dielectric lithium-based particles, in accordance with the present disclosure.

FIG. 5 is a graphical representation illustrating an improvement in cycling when using the cathode with nano-sized dielectric lithium-based particles, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

In the field of lithium-ion batteries, elevating the cutoff voltages to higher levels (e.g., above 4.4 V, above 4.25 V) is a common approach to enhance energy density. However, this practice leads to the decomposition of electrolytes, resulting in the formation of hydrofluoric acid (HF). The presence of HF is detrimental as it causes the dissolution of transitional metals in the cathode active materials. This dissolution is one of the primary causes of battery degradation, significantly impacting the cycle life of battery cells.

To address this issue, various methods, for example electrolyte engineering and materials modifications, have been explored to suppress the effects of HF and prolong the cycle life of batteries. Conventional approaches include powder surface treatments, e.g. lithium aluminum titanium phosphate (LATP) coatings or blending powders with micron-sized particles during the mixing process. While these methods are effective, they often require substantial amounts of LATP or complicated treatment process, which can be costly and inefficient.

The cathode and battery disclosed herein introduces an approach to mitigate HF-induced degradation. Instead of relying on conventional powder surface treatments or blending techniques, the cathode and battery cell disclosed herein utilize a nano-sized particles. This significantly reduces the amount of nano-sized particles required without compromising its beneficial effects. By incorporating nano-sized particles, the cathode and battery ensures a more efficient and effective suppression of HF-induced transitional metal dissolution, thereby enhancing the cycle life of lithium-ion battery cells.

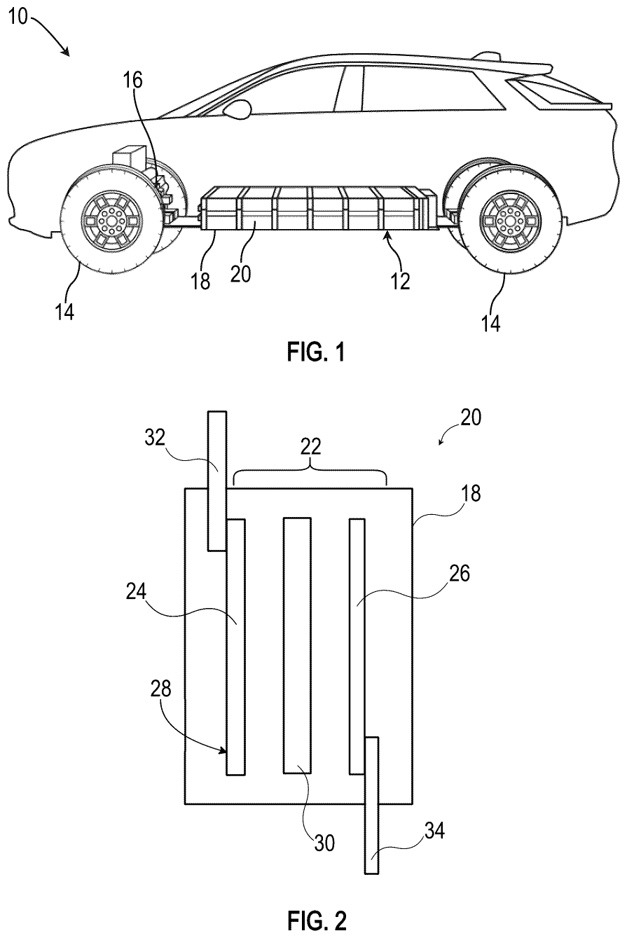

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 14 driven by at least one electric motor/inverter 16. The electric motors/inverters 16 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. The battery pack 12 includes a housing 18 for carrying and supporting a plurality of battery cells 20. In an example, the battery pack 12 may have fifty or more battery cells 20.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

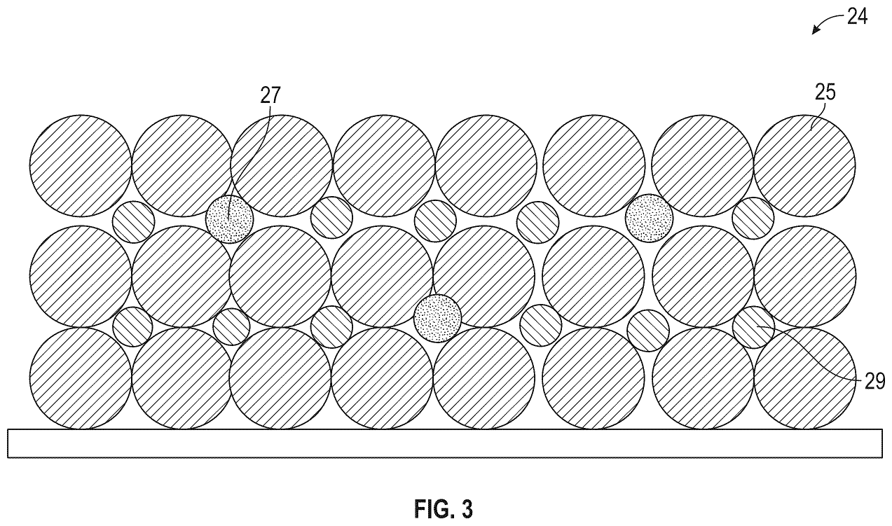

FIG. 2 is a schematic illustration showing one battery cell 20 within the battery pack 12 illustrated in FIG. 1. The battery pack 12 and the battery cells 20 are understood to be rechargeable batteries that may be discharged upon application of a load and recharged upon the application of an external power source. The battery cells 20 may be, for example, pouch-style, prismatic, and/or cylindrical-style cells.

Each battery cell 20 disposed within the battery pack 12 shown in FIG. 1 has at least one electrode stack 22, which further includes a cathode 24, an anode 26, an electrolyte 28, and/or a separator 30. Each battery cell 20 may have tens or hundreds of electrode stacks 22. Each electrode stack 22 is connected to a cathode current collector 32 and an anode current collector 34. The electrode stacks are placed in the housing 18, which may be filled with the electrolyte 28 in the case of a liquid electrolyte. The electrolyte may be liquid and/or solid. The electrolyte 28 transports ions between the cathode 24 and the anode 26. The cathode current collector 32 and the anode current collector 34 are thin metal plates or foils disposed on sides of the electrode stacks 22 and/or housing 18 and typically have a thickness between 0.1 and 1 millimeter. The cathode current collector 32 and the anode current collector 34 may be made of copper or aluminum and are attached to the electrode stacks 22 to transmit the electric current to an external circuit (not shown).

During electrical discharge, when a load is applied to the battery cells 20, Li⁺ ions move from the anode 26 to the cathode 24 through the separator 30 by way of the electrolyte 28. Equivalent electrons e⁻ move through battery circuitry from the cathode 24 to the anode 26, providing energy to a battery load. While charging and upon application of an external voltage, Li⁺ ions move from the cathode 24 to the anode 26 by way of the electrolyte 28 through the separator 30 and may be intercalated into the anode 26.

Each battery cell 20 generally includes the cathode current collector 32, the cathode 24 disposed on at least one surface of the cathode current collector 32, the anode current collector 34, the anode 26 disposed on at least one surface of the anode current collector 34, the separator 30 positioned between the cathode 24 and anode 26, and an electrolyte 28. While the illustrated battery cells 20 include one anode 26 (and anode current collector 34) and one cathode (and one cathode current collector 32), the battery cell 20 may alternatively include two or more cathodes 24 (and cathode current collectors 32) and one or more anodes 26 (and anode current collectors 34). In further alternative embodiments, the battery cell 20 may include or one or more cathodes 24 (and cathode current collectors 32) and two or more anodes 26 (and anode current collectors 34). In any of the designs above, one or more separators 30 can be interleaved between the cathodes 24 and anodes 26 to prevent the cathodes 24 and the anodes 26 from contacting.

The cathode current collector 32 and anode current collector 34 are formed from conductive materials. In embodiments, the cathode current collector 32 includes aluminum. Alternatively, or additionally, the cathode current collector 32 may include copper clad aluminum, stainless steel, and/or other suitable materials. The anode current collector 34 may include one or more of copper, nickel, stainless steel, and/or titanium. The cathode current collector 32 and the anode current collector 34 are illustrated as being in the form of a foil. However, it will be appreciated that other forms may be exhibited, such as a mesh or a composite-type material.

As shown in FIG. 3, he cathode 24 includes a cathode active material 25 configured to provide a source of lithium ions (Li⁺) and undergo reversible insertion or intercalation of lithium ions determining, for example, the capacity and average voltage of a battery. The cathode active material 25 may include at least one of nickel cobalt manganese (NCM), nickel cobalt aluminum oxide (NCA), nickel manganese (NMₓ), lithium nickel cobalt manganese aluminum (NCMA), lithium manganese rich (LMR), lithium manganese oxide (LMO), lithium nickel manganese oxide (LNMO), lithium nickel manganese aluminum oxide (NMA), lithium iron phosphate (LFP), or lithium iron manganese phosphate (LFMP), or lithium cobalt oxide (LCO). Additionally, the cathode 24 and the cathode active material 25 may include one or more transition metals. For example, the transition metals may include at least one of manganese (Mn), cobalt (Co), nickel (Ni), aluminum (Al), magnesium (Mg), titanium (Ti), zirconium (Zr), molybdenum (Mo), or niobium (Nb). In an example, the cathode active materials 25 have single-crystal structure with a particle size (D50) between 1-5 microns (um). In a more specific example, the particle size of cathode active materials 25 is between 24 um.

In FIG. 3, the cathode 24 (i.e., “cathode electrode”) includes nanoparticles 27 dispersed in the cathode active material 25. The nanoparticles 27 include dielectric lithium-conductive particles, for example lithium aluminum titanium phosphate (LATP). In an example, the nanoparticles 27 can have a median particle size (D50) between 100 and 500 nanometers (nm). In a more specific example, the nanoparticles 27 can have a median particle size (D50) between 200 and 400 nanometers (nm). It will be appreciated that the nanoparticles 27 may have additional or various median particle sizes or combinations of sizes. Some examples of the nanoparticles 27 include LATP, lithium zirconate (LiZrO₃), lithium niobate (LiNbO₃), and/or lithium tantalate (LiTaO₃). In an additional example, the nanoparticles 27 are between 0.5-1.5 wt. % of the cathode 24. Using nanoparticles 27 in the cathode active material 25 significantly decreases the amount of LATP usage without sacrificing the benefits of discharge rate performance.

The cathode 24 includes a conductive filler 29. The conductive filler 29 may include, for example, carbon nanotubes (e.g., single walled carbon nanotubes (SCNT), multi-walled carbon nanotubes (MCNT)), Super P (SP), conductive polymers (e.g., poly(3,4-ethylenedioxythiophene)-poly(styrenesulfonate)), graphene, and/or conventional carbon black additives. The conductive fillers 29 can be integrated into the cathode active material 25 to form a continuous conductive network. This conductive network significantly improves electron transport and reduces internal resistance, thereby enhancing the overall efficiency and rate capability of the battery.

The cathode also includes a binder. The binder ensures adhesion of the cathode active materials 25 to the current collectors, thereby maintaining electrode coherency during charge and discharge cycles. The binder may include, for example, poly(vinylidene fluoride) (PVDF), poly(vinylidene fluoride-co-hexafluoropropylene) (PVdF-HFP), polytetrafluoroethylene (PTFE), sodium carboxymethyl cellulose (CMC), styrene-butadiene rubber (SBR), nitrile butadiene rubber (NBR), styrene ethylene butylene styrene copolymer (SEBS), polyethylene oxide (PEO), polyvinylpyrrolidone (PVP), poly(vinyl alcohol), or poly(acrylic acid) (PAA), and the like.

In one specific example, the cathode includes cathode active material 25 between 77-98.9 wt. %, nanoparticles 27 between 0.1-3 wt. %, the conductive filler between 0.5-5 wt. %, and the binder between 0.5-8 wt. %.

The anode 26 includes materials that undergo reversible insertion or intercalation of lithium ions at a lower electrochemical potential than the cathode 24 material such that an electrochemical potential difference exists between the anode 26 and cathode 24. The anode 26 may include one or more of lithium metal; alloys of lithium for example lithium silicon alloy, lithium aluminum alloy, lithium indium alloy, lithium titanate (LTO), and lithium tin alloy; carbon based materials, for example graphite, activated carbon, carbon black and graphene; silicon; silicon based alloys; silicon oxide; silicon based composite materials; silicon carbon composite; titanium niobium oxide (TNO); tin oxide; aluminum; indium; zinc; germanium; and/or titanium oxide; as well as any combination of the above. In an embodiment, the anode 26 may exhibit a thickness in the range of 50 micrometers to 150 micrometers including all values and ranges therein.

Referring again to FIG. 2, the separator 30 is a porous material formed of an electrically insulative material that prevents the cathode 24 and the anode 26 from contacting and potentially shorting out the battery circuit. The separator 30 is sandwiched, or at least partially enclosed, between the cathode 24 and anode 26 allowing the passage of the lithium ions (Li⁺) and/or electrolyte 28 through the pores of the separator 30. The separator 30 may include one or more of a composite material, a polymeric material, or a non-woven material, for example.

In embodiments, the separator 30 includes at least one of polyethylene, polypropylene, polyamide, polytetrafluoroethylene, polyvinylidene fluoride, and/or polyvinyl chloride. Additionally, the separator 30 may be filled (e.g., include fillers dispersed therein), wherein the filler includes a material such as glass fiber. In additional or alternative embodiments, the separator 30 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 30 may include one or more layers, wherein each layer is formed from one or more of the materials noted above. In some instances, the separator 30 may take the form of film or a mesh, such as woven mesh or a slit film. In embodiments, the separator 30 exhibits a thickness in the range of 4 micrometers to 25 micrometers, including all values and ranges therein.

Still referring to FIG. 2, the electrolyte 28 provides a medium between the cathode 24 and anode 26 through which lithium ions travel. The medium may be a liquid, gel, or solid, and is capable of conducting the lithium ions between the cathode 24 and the anode 26. The electrolyte 28 permeates the pores of the porous separator 30 and wets or otherwise contacts the surfaces of the cathode 24 and anode 26 as well as the separator 30.

In embodiments, the electrolyte 28 includes one or more lithium salts dissolved in non-aqueous organic solvent. Some example of lithium salts may include one or more of lithium hexafluorophosphate (LiPF6), lithium perchlorate (LiClO4), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl) imide (LiN(F_{S}O₂)₂) (LiSFI), lithium (triethylene glycol dimethy 1 ether)bis(trifluoromethanesulfonyl)imide (Li(G₃)(TFSI), and/or lithium bis(trifluoromethanesulfonyl)azanide (LiTFSA). In non-limiting examples, the lithium salt may be present in the electrolyte 28 at a concentration ranging from 1 moles (M) of salt per liter of solvent to 4 M, including all values and ranges therein, for example 2 M or 3 M.

The non-aqueous aprotic organic solvent can include one or more of various alkyl carbonates, for example cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxy ethane), and/or cyclic ethers (e.g., tetrahydrofuran, 2-methyltetrahydrofuran), 1,3-dioxolane).

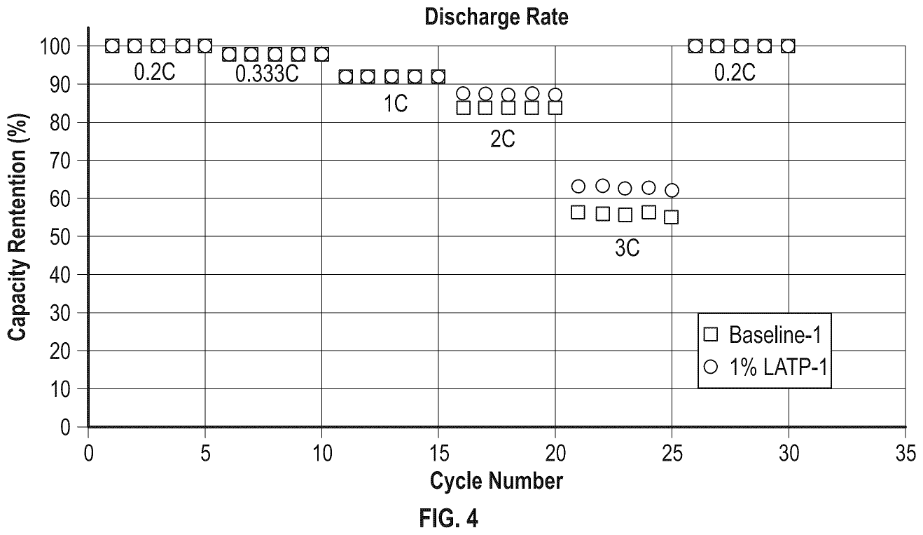

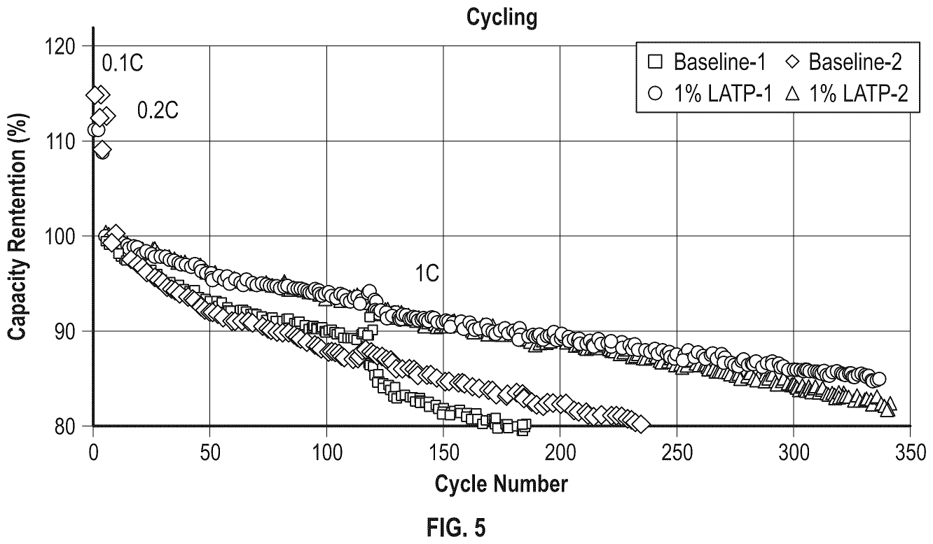

In a specific example, the cathode 24 included a cathode active material 25 including NCM613 (lithium nickel cobalt manganese oxide (LiNi_{0.6}Co_{0.1}Mn_{0.3}O₂)) at a concentration of 94 wt. %, nanoparticles 27 (e.g., LATP with a median particle size (D50) of about 400 nanometers (nm)) at a concentration of 1 wt. %, a conductive filler 29 including SP with a concentration of 2.9 wt. % and SCNT with a concentration of 0.1 wt. %, and a binder including PVDF with a concentration of 1.97 wt. %. The term “about” will be understood by one of skill in the art. Alternatively, the term “about” means plus or minus 10 nm. In this example, the cathode 24 included a loading of 4.0 milliamp hours per square centimeter (mAh/cm²), a voltage range between 3.0 and 4.45 volts (V), and an electrolyte of 1 molar (M) LiPF6 in ethylene carbonate (EC)/ethyl methyl carbonate (EMC) (3% volume (vol.)/7% vol.) plus 2 wt. % fluoroethylene carbonate (FEC) plus 1 wt. % vinylene carbonate (VC). A baseline cathode included a cathode active material including NCM 613 at a concentration of 95 wt. %, a conductive filler including SP with a concentration of 2.9 wt. % and SCNT with a concentration of 0.1 wt. %, and a binder including PVDF with a concentration of 2 wt. %. As shown by the results illustrated in FIGS. 4 and 5, a cathode 24 including nanoparticles including LATP 1 wt. %, the discharge rate and cycling stability were significantly improved compared with the baseline cathode composition not having the nanoparticles.

The vehicle battery cell 20 and battery pack 12 for the vehicle 10 of the present disclosure is advantageous and beneficial over prior art. Instead of relying on conventional powder surface treatments or blending techniques, By incorporating nano-sized particles, the cathode and battery ensures a more efficient and effective suppression of HF-induced transitional metal dissolution, thereby enhancing the cycle life of lithium-ion battery cells. This significantly reduces the amount of particles required without compromising its beneficial effects.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A cathode for a battery cell, comprising:
cathode active materials;
nanoparticles dispersed in the cathode active material, wherein the nanoparticles are dielectric lithium-conductive particles and include lithium aluminum titanium phosphate (LATP), and wherein the nanoparticles have a median particle size (D50) between 100 and 500 nanometers (nm);
a conductive filler; and
a binder.

2. The cathode of claim 1, wherein the battery cell operates under a cutoff voltage higher than 4.25 V.

3. The cathode of claim 1, wherein the cathode active material includes at least one of lithium nickel manganese cobalt oxide (NCM), nickel manganese (NM) (where the nickel is greater than 70 wt. %), lithium manganese rich (LMR), lithium nickel manganese oxide (LNMO), or lithium cobalt oxide (LCO) with a single crystal structure.

4. The cathode of claim 3, wherein the cathode active material has a single-crystal structure.

5. The cathode of claim 3, wherein the cathode active material has a median particle size (D50) between 2 microns (μm) and 4 microns (μm).

6. The cathode of claim 1, wherein the conductive filler includes at least one of carbon nanotubes, graphene, or a conductive polymer.

7. A battery for an electric vehicle, comprising:
a battery cell, the battery cell including:
a cathode current collector;
a cathode disposed on at least one surface of the cathode current collector, wherein the cathode includes
a cathode active material;
nanoparticles dispersed in the cathode active material, wherein the nanoparticles include dielectric lithium-conductive particles, and wherein the nanoparticles have a median particle size (D50) between 100 and 500 nanometers (nm);
a conductive filler; and
a binder;
an anode disposed on an anode current collector, wherein the anode includes at least one of graphite, silicon, a silicon carbon composite, lithium titanate (LTO), or titanium niobium oxide (TNO);
a separator positioned between the cathode and the anode; and
an electrolyte configured for carrying ions between the cathode and the anode.

8. The battery for the electric vehicle of claim 7, wherein the battery cell operates under a cutoff voltage higher than 4.25 V.

9. The battery for the electric vehicle of claim 7, wherein the cathode active material includes at least one of lithium nickel manganese cobalt oxide (NCM), nickel manganese (NM) (where the nickel is greater than 70 wt. %), lithium manganese rich (LMR), lithium nickel manganese oxide (LNMO), or lithium cobalt oxide (LCO).

10. The battery for the electric vehicle of claim 9, wherein the cathode active material has a single-crystal structure.

11. The battery for the electric vehicle of claim 7, wherein the cathode active material includes at least one of lithium manganese oxide (LMO), lithium nickel manganese aluminum oxide (NCMA), nickel cobalt aluminum oxide (NCA), lithium nickel manganese aluminum oxide (NMA), lithium iron phosphate (LFP), or lithium iron manganese phosphate (LFMP).

12. The battery for the electric vehicle of claim 7, wherein the cathode active material has a median particle size (D50) between 2 microns (μm) and 4 microns (μm).

13. The battery for the electric vehicle of claim 7, wherein the nanoparticles include lithium aluminum titanium phosphate (LATP).

14. The battery for the electric vehicle of claim 7, wherein the nanoparticles include at least one of lithium zirconate (LiZrO₃), lithium niobate (LiNbO₃), or lithium tantalate (LiTaO₃).

15. The battery for the electric vehicle of claim 7, wherein the nanoparticles are between 0.5-1.5 wt. % of the cathode.

16. The battery for the electric vehicle of claim 7, wherein the nanoparticles have a median particle size (D50) between 200 and 400 nanometers (nm).

17. The battery for the electric vehicle of claim 7, wherein the conductive fillers include at least one of carbon nanotubes, graphene, or a conductive polymer.

18. The battery for the electric vehicle of claim 7, wherein the binder is polyvinylidene fluoride (PVDF).

19. The battery for the electric vehicle of claim 7, wherein the cathode includes cathode active materials between 77-98.9 wt. %, nanoparticles between 0.1-3 wt. %, a conductive filler between 0.5-5 wt. %, and a binder between 0.5-8 wt. %.

20. A battery for an electric vehicle, comprising:
a battery cell, the battery cell including:
a cathode current collector;
a cathode disposed on at least one surface of the cathode current collector, wherein the cathode includes
a cathode active material including lithium nickel cobalt manganese oxide;
nanoparticles dispersed in the cathode active material, wherein the nanoparticles include dielectric lithium-conductive particles, and wherein the nanoparticles have a median particle size (D50) of about 400 nanometers (nm);
a conductive filler including single-walled carbon nanotubes; and
a binder;
an anode disposed on an anode current collector, wherein the anode includes at least one of graphite, silicon, a silicon carbon composite, lithium titanate (LTO), or titanium niobium oxide (TNO);
a separator positioned between the cathode and the anode; and
an electrolyte configured for carrying ions between the cathode and the anode.
